(19) United States
(12) Patent Application Publication
(10) Pub. No.: US 2025/0016279 A1
(43) Pub. Date: Jan. 9, 2025

(54) INFORMATION PROCESSING SYSTEM, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Ryumon TAJIMA, Kanagawa (JP)

(73) Assignee: FUJIFILM Business Innovation Corp., Tokyo (JP)

(21) Appl. No.: 18/427,839

(22) Filed: Jan. 31, 2024

(30) Foreign Application Priority Data
Jul. 6, 2023 (JP) 2023-111641

(51) Int. Cl. H04N 1/00

(52) U.S. Cl. CPC H04N 1/00949; H04N 1/0048; H04N 2201/3246

(57) ABSTRACT

An information processing system includes: one or more processors configured to: acquire a workflow directed to a user who uses an information processing apparatus and usage information in association with each other, the usage information indicating a communication line used in receiving the workflow by the information processing apparatus receiving workflows by using multiple independent communication lines including the communication line; and in response to inconsistency between the usage information and permission information indicating a communication line of the communication lines that is permitted to be used by the user, report warning to the user without displaying, on a display, the workflow associated with the usage information.

### CROSS-REFERENCE TO RELATED APPLICATIONS

This application is based on and claims priority under 35 USC 119 from Japanese Patent Application No. 2023-111641 filed Jul. 6, 2023.

### BACKGROUND

### (i) Technical Field

The present disclosure relates to an information processing system, a non-transitory computer readable medium, and an information processing method.

### (ii) Related Art

Japanese Unexamined Patent Application Publication No. 2019-22171 discloses a communication control device connected to multiple independent communication lines through which communications are performed. The communication control device has a memory and a determination unit. The memory stores user information on a per-user basis, and the determination unit determines whether a communication line intended to be used is usable on the basis of user information regarding a user who intends to use the communication line.

### SUMMARY

Some information processing apparatuses configured to be connected to multiple independent communication lines have, on occasions, security requirements that data is not to be exchanged between different communication lines. In this case as described, if a communication line used in receiving a workflow directed to a user authenticated for an information processing apparatus is different from a communication line permitted to be used by the user, the workflow is not sometimes displayed on the display. At this time, it appears as if the workflow were not received from a communication line different from the permitted communication line, and thus it is difficult for the user to notice an issue of a setting mistake related to communication line permission.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

Aspects of non-limiting embodiments of the present disclosure relate to an information processing system including: one or more processors configured to: acquire a workflow directed to a user who uses an information processing apparatus and usage information in association with each other, the usage information indicating a communication line used in receiving the workflow by the information processing apparatus receiving workflows by using multiple independent communication lines including the communication line; and in response to inconsistency between the usage information and permission information indicating a communication line of the communication lines that is permitted to be used by the user, report warning to the user without displaying, on a display, the workflow associated with the usage information.

### BRIEF DESCRIPTION OF THE DRAWINGS

An exemplary embodiment of the present disclosure will be described in detail based on the following figures, wherein:

FIG. 1 is a view illustrating an example of the configuration of a communication environment including an information processing system to which this exemplary embodiment is applied;

FIG. 2 is a view illustrating an example of the hardware configuration of the image processing apparatus according to this exemplary embodiment;

FIG. 3 is a view illustrating an example of the functional configuration of the image processing apparatus according to this exemplary embodiment;

FIG. 4 is a flowchart illustrating an example flow of a process for reporting warning to a utilizer;

FIG. 5 is a flowchart illustrating the flow of a process for reporting to an administrator;

FIG. 6 is a view illustrating one of example displays on a display to which this exemplary embodiment is applied;

FIG. 7 is a view illustrating a different one of the example displays on the display to which this exemplary embodiment is applied;

FIG. 8 is a view illustrating a different one of the example displays on the display to which this exemplary embodiment is applied;

FIG. 9 is a view illustrating a different one of the example displays on the display to which this exemplary embodiment is applied; and

FIGS. 10A and 10B are views each illustrating a different one of the example displays on the display to which this exemplary embodiment is applied and respectively illustrating an operation screen for receiving administrator login and an operation screen displaying a report to the administrator.

### DETAILED DESCRIPTION

Hereinafter, an exemplary embodiment of the present disclosure will be described in detail with reference to the attached drawings.

### Communication Environment Configuration

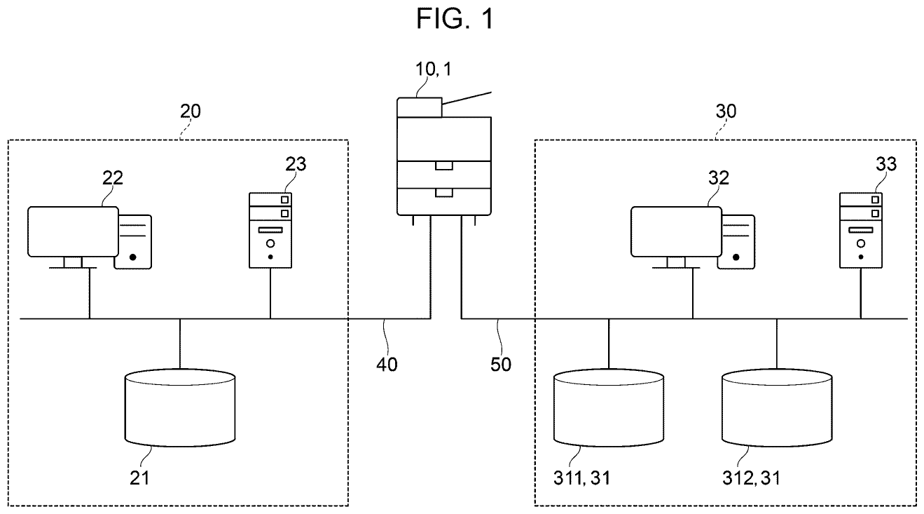

FIG. 1 is a view illustrating an example of the configuration of a communication environment including an information processing system 1 to which this exemplary embodiment is applied.

The information processing system 1 according to this exemplary embodiment is implemented in an image processing apparatus 10 that receives workflows by using multiple independent communication lines. The image processing apparatus 10 has a so-called multi-interface configuration including multiple communication interfaces (hereinafter, referred to as communication I/Fs) and is connected to the multiple communication lines.

In the example illustrated in FIG. 1, the image processing apparatus 10 is connected to a first network 20 via a first communication line 40 and is also connected to a second network 30 via a second communication line 50. The first network 20 is connected to a workflow system 21, a terminal apparatus 22, and a document management server 23. In the workflow system 21, workflows are managed. In each workflow, the order of processes is predetermined. The terminal apparatus 22 sets and executes the workflow. The document management server 23 manages documents transmitted and received in the workflow. The second network 30 is connected to multiple workflow systems 31 (311 and 312), a terminal apparatus 32, and a document management server 33. In this exemplary embodiment, the communication line is not particularly limited as long as the communication line achieves information communication between the apparatuses. Any communication line may be used regardless of wired communication or wireless communication, and both may be used.

In this exemplary embodiment, the term “workflow” denotes the flow of a series of processes in performing work and includes processes to be executed in the image processing apparatus 10. The phrase “receive a workflow” denotes receiving an instruction related to processes included in the workflow and workflow information such as a workflow name.

The term “document” denotes an electronic document and may include not only text but also an image. The document may also exclude text and include an image only. A data file for the document may include not only image data and document data but also image information used in converting document data into an image and attribute information such as a date and time when an electronic document is updated, a sheet size, the number of pages, and a keyword in the electronic document.

The image processing apparatus 10 according to this exemplary embodiment is an information processing apparatus that executes a process included in the workflow on the basis of operation by a user who uses the information processing system 1. The image processing apparatus 10, for example, acquires various pieces of information transmitted from the first network 20 and the second network 30 to execute various processes and transmits various pieces of information to the first network 20 and the second network 30.

The image processing apparatus 10 executes, for example, a process for reading an image formed on the paper sheet or the like, a process for forming an image on the medium such as a paper sheet, and a process for outputting a recording medium having an image formed thereon. Examples of the image processing apparatus 10 include what is called a scanner that reads an original placed on the platen glass, what is called an electrophotographic-system-based multifunction printer that forms a toner image on the printing side of a paper sheet, and what is called an inkjet-system-based printer that jets out ink on the printing side of a paper sheet.

The image processing apparatus 10 decides a communication I/F accessible by a user on the basis of information set on a per-user basis. For example, users who operates the image processing apparatus 10 are classified into a user who uses the image processing apparatus 10 (hereinafter, referred to as a utilizer) and a user who manages the image processing apparatus 10 (hereinafter, referred to as an administrator). The image processing apparatus 10 identifies the utilizer or the administrator on the basis of a right assigned to the user or the type or the like of user authentication. The image processing apparatus 10 decides a communication I/F accessible by the utilizer as a communication I/F to be connected to the communication line in advance permitted to be used by the utilizer. In contrast, the image processing apparatus 10 decides a communication I/F accessible by the administrator as one of all of the communications I/F of the image processing apparatus 10. When discrimination between the utilizer and the administrator is not particularly required, the utilizer and the administrator are simply and collectively referred to as a user on occasions.

On the basis of information regarding a communication line, the image processing apparatus 10 decides whether to present, to a utilizer, a workflow directed to the utilizer. The term “workflow directed to a utilizer” denotes a workflow including a process requiring operation by the utilizer. Examples of the information regarding a communication line include information indicating a communication line or the like permitted to be used by the utilizer (hereinafter, referred to as permission information) and information indicating a communication line or the like used in receiving the workflow directed to the utilizer (hereinafter, referred to as usage information). Specifically, the image processing apparatus 10 decides that, among workflows directed to utilizers, a workflow with usage information that matches permission information (hereinafter, referred to as an information-consistent workflow) is to be presented and that a workflow with the usage information that does not match the permission information (hereinafter, referred to as an information-inconsistent workflow) is not to be presented and warning is to be reported.

The information processing apparatus is not limited to the image processing apparatus 10. As long as the apparatus has the multi-interface configuration and is capable of performing data exchange with a different information apparatus through connection to multiple communication lines, the specific type of the apparatus is not limited. For example, a computer or the like is usable as the information processing apparatus. It is assumed that the information processing apparatus in this exemplary embodiment is used by multiple users and that a communication I/F accessible is set on a per-user basis.

The first network 20 and the second network 30 in this exemplary embodiment are networks connected through different communication lines. The first network 20 and the second network 30 are independent of each other, and networks are established, for example, on a per-utilizer basis or an on a per-data basis. A security requirement in a multiple-network environment is that data is not to be exchanged between the first network 20 and the second network 30. Other cited security requirements are that if an instruction to acquire or transmit data is issued, only a network used for receiving the instruction is to be permitted to exchange data and that the address book stored in the image processing apparatus 10, pieces of history information or the like regarding executed processes are to be divided on a per-network basis.

If the image processing apparatus 10 is shared by utilizers belonging to different departments, for example, the first network 20 and the second network 30 may be dedicated to Department A and Department B, respectively. If the image processing apparatus 10 handles pieces of data with different security levels, for example, the first network 20 and the second network 30 may respectively be the Internet serving as a network publicly available and an intranet serving as a network available in a local area.

The workflow systems 21 and 31 (311 and 312) in this exemplary embodiment are a system for managing workflows according to which processes are executed in sequence in a predetermined order. In accordance with the workflow in which the order of the processes are predetermined, for example, the workflow systems 21 and 31 (311 and 312) automatically request the execution of the processes in the image processing apparatus 10 and perform information communication between the apparatuses. The workflow systems 21 and 31 may be configured, for example, by using one server or multiple servers. The workflow systems 21 and 31 may be configured as what is called a cloud server or an on-premises server.

The terminal apparatuses 22 and 32 in this exemplary embodiment are each an information processing apparatus that sets a workflow and executes processes on the basis of operations by each user who uses a corresponding one of the workflow systems 21 and 31. A user who uses one of the terminal apparatuses 22 and 32 may be the same user as the utilizer or the administrator of the image processing apparatus 10 or may be a user different from the utilizer or the administrator. The terminal apparatuses 22 and 32 are implemented by, for example, a computer, a tablet information terminal, a smartphone, a gaming machine, or another information processing apparatus.

The document management servers 23 and 33 in this exemplary embodiment are each a server apparatus that manages documents exchanged in the course of the workflow. For example, as a process included in the workflow, the document management servers 23 and 33 each manage an image read by the image processing apparatus 10. The document management servers 23 and 33 may be configured by using, for example, one server or multiple servers. The document management servers 23 and 33 may be configured as what is called a cloud server or an on-premises server.

The information apparatuses connected to the first network 20 and the second network 30 are not limited to the example illustrated in FIG. 1. For example, multiple terminal apparatuses in addition to the workflow system 21 may be connected to the first network 20, and a document management server does not have to be connected thereto. Multiple terminal apparatuses in addition to the workflow systems 31 may also be connected to the second network 30, and a document management server does not have to be connected thereto.

The above-described configuration of the information processing system 1 is an example. It suffices that the information processing system 1 has functions of implementing the processes described above as a whole. Accordingly, part or all of the functions for implementing the processes may be performed in charge or in cooperation in the information processing system 1. A different information apparatus may thus have part or all of the functions of the image processing apparatus 10. Further, part or all of the functions of the image processing apparatus 10 included in the information processing system 1 may be transferred to a different server or the like (not illustrated). This enables the processes by the information processing system 1 to be accelerated as a whole and also enables the processes to be complemented with each other.

Hereinafter, the overview of the functions of the image processing apparatus 10 of this exemplary embodiment to which the information processing system 1 is applied will be described. The description is provided on the assumption that permission information indicating a communication line permitted to be used for the image processing apparatus 10 is set on a per-utilizer basis and that a utilizer intends to execute a workflow by using the image processing apparatus 10.

The image processing apparatus 10 identifies the utilizer through user authentication. The image processing apparatus 10 acquires workflows directed to the identified utilizer from the workflow systems 21 and 31. The image processing apparatus 10 performs, on the display, indication regarding the acquired workflows and based on the usage information and the permission information. Specifically, the image processing apparatus 10 handles the acquired workflows in the following manner. The image processing apparatus 10 displays a list of one or more information-consistent workflows). The image processing apparatus 10 does not display one or more information-inconsistent workflows and reports warning to the utilizer.

The image processing apparatus 10 of this exemplary embodiment has the functions described above, and thus warning regarding a workflow received through a communication line different from the communication line permitted to the utilizer is reported to the utilizer. Specifically, with the security requirements in the multiple-network environment being ensured, the warning regarding the workflow received through the different communication line is reported to the utilizer. Even though the content of the workflow received through the different communication line is not presented to the utilizer, this exemplary embodiment causes the utilizer to notice inconsistence between the permission information and the usage information. For example, the utilizer notices that the permission information does not include a communication line used in actually acquiring the workflow and thus the permission information has been set by mistake. In addition, for example, the utilizer notices that there is a workflow not presented and a workflow is acquired through an unfavorable network communication line.

This exemplary embodiment ensures the security requirements in the multiple-network environment and also contributes to causing the utilizer to notice an issue related to a communication line in the case where a workflow is received through a different communication line not permitted to be used by the utilizer.

### Configuration of Image Processing Apparatus 10

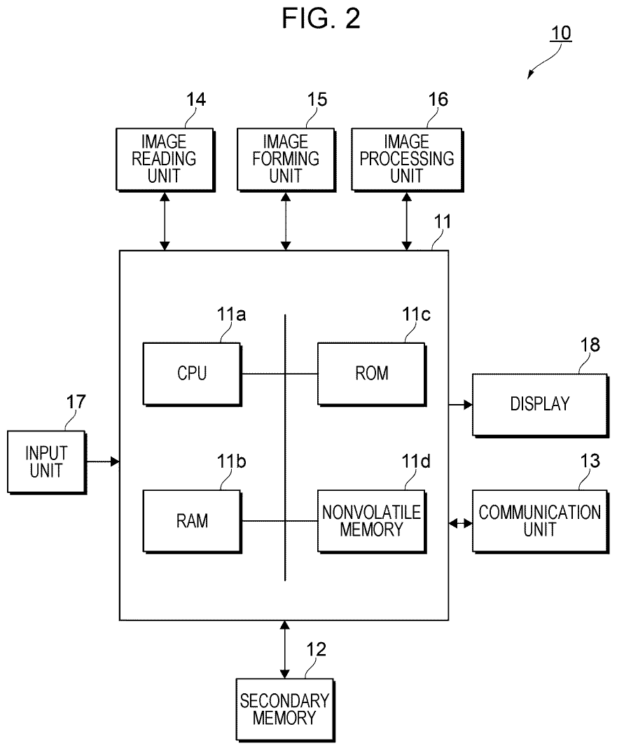

FIG. 2 is a view illustrating an example of the hardware configuration of the image processing apparatus 10 according to this exemplary embodiment.

The image processing apparatus 10 has a controller 11 that performs control of overall apparatus operation, a secondary memory 12 that stores image data and the like, a communication unit 13 that implements communication with a different apparatus, an image reading unit 14 that reads an image of an original, an image forming unit 15 that forms an image on the paper sheet that is an example of a recording medium, and an image processing unit 16 performs processing such as color correction and tone correction on image data or document data. The image processing apparatus 10 also has an input unit 17 that receives an input operation from a user and a display 18 that displays information to the user. The controller 11 and the different processing unit are connected via a bus or a signal line.

The controller 11 includes a central processing unit (CPU) 11a that performs overall apparatus control and that is an example of the processor, a random access memory (RAM) 11b used as a work memory or the like for the CPU 11a, and a read only memory (ROM) 11c that stores programs and the like to be run by the CPU 11a. The controller 11 also includes a re-writable nonvolatile memory 11d capable of holding data even if power supply is interrupted. The nonvolatile memory 11d is configured as, for example, a static RAM (SRAM) with battery backup or a flash memory and stores the permission information, the usage information, and the like. The controller 11 loads a program stored in the secondary memory 12, and thereby the corresponding process for the image processing apparatus 10 of this exemplary embodiment is executed.

The programs run by the CPU 11a may be provided in such a manner as to be stored in a computer readable recording medium such as a magnetic recording medium (such as a magnetic tape or a magnetic disk), an optical recording medium (such as an optical disk), a magneto-optical recording medium, or a semiconductor memory. The programs run by the CPU 11a may be provided by using a communication medium such as the Internet.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The secondary memory 12 is configured as, for example, a hard disk device (HDD) that is a nonvolatile storage or a semiconductor memory. The secondary memory 12 stores workflow information received from an external apparatus, image data read by the image reading unit 14, image data received from an external apparatus through communication, image data transmitted or received through facsimile communication, and the like. In addition to these, the secondary memory 12 stores programs to be run by the controller 11, user information, permission information, usage information, an address book, history information regarding executed processes, and the like.

The communication unit 13 at least has a first communication I/F and a second communication I/F. The first communication I/F is a communication interface for connecting to the first network 20 via the first communication line 40. The first communication I/F has, for example, an address (for example, an internet protocol (IP) address) in the first network 20. The second communication I/F is a communication interface for connecting to the second network 30 via the second communication line 50. The second communication I/F has, for example, an address (for example, an IP address) in the second network 30. The first communication I/F and the second communication I/F may be implemented by using separate network cards or connectors.

The image reading unit 14 is what is called a scanner and supports both of a mode for reading an image while moving the reading unit relative to the original in a stationary state and a mode for reading an image while moving the original relative to the reading unit in the stationary state.

The image forming unit 15 is a processing unit that forms an image on the recording medium such as a paper sheet and has a mechanism appropriate for the image forming system therefor. As a recording material, for example, toner or ink is used.

The image processing unit 16 is composed of a processor specially for processing image data, a processing circuit, or the like.

The input unit 17 is a switch, a button, a touch panel, or the like used for receiving an input operation from a user. In addition to these, the input unit 17 may have a code reader for code information such as a QR code (registered trademark) or a bar code, a card reader for an integrated circuit (IC) card such as an employee identification card, a sensor that reads biometric information such as the fingerprint of a user or the vein layout, and the like. The input unit 17 may also have a communication device that performs wireless communication with a user terminal (not illustrated) of the user through Bluetooth (registered trademark), near field communication (NFC), or the like.

In accordance with user operation with the input unit 17, a position on the operation screen displayed on the display 18 (described later) is designated, or an image displayed on the display 18 is designated. In accordance with operation by the user with the input unit 17, user information regarding the user may be acquired.

The display 18 is composed of, for example, a liquid crystal display or an organic electroluminescence (EL) display and is used to display an image, text information, and the like to a user who operates the image processing apparatus 10.

If the display 18 is composed of what is called a touch panel, the input unit 17 and the display 18 are integrally provided.

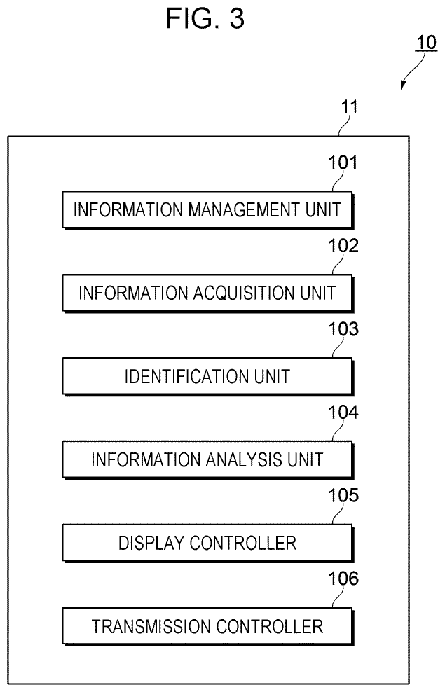

FIG. 3 is a view illustrating an example of the functional configuration of the image processing apparatus 10 according to this exemplary embodiment. The functions of the image processing apparatus 10 illustrated in FIG. 3 are implemented mainly by the CPU 11a of the controller 11 (see FIG. 2).

As illustrated in FIG. 3, the image processing apparatus 10 includes an information management unit 101 that manages various pieces of information, an information acquisition unit 102 that acquires various pieces of information, an identification unit 103 that identifies a user who operates the image processing apparatus 10, an information analysis unit 104 that analyzes various pieces of information, a display controller 105 that controls displaying by the display 18 (see FIG. 2), and a transmission controller 106 that controls various pieces of information.

The information management unit 101 stores various pieces of information in a database in the secondary memory 12 (see FIG. 2) and manages the pieces of information. For example, the information management unit 101 stores and manages user information and permission information set in advance on a per-user basis in association with each other.

The user information is information used for user authentication. For the user information, identifications such as a user identification (ID) and biometric information that uniquely identify a user, identifications such as a password, a user name, and a card ID that uniquely identifies a card for authentication distributed to a user, the scope of a right assigned to a user, and the like are cited.

The permission information is information used to identify a communication line, a communication I/F, and a network that are permitted to be used by a utilizer. For the permission information, an identification or the like is cited, the identification uniquely identifying a communication line permitted to be used by a user if the user applies to a utilizer. The identification may be an identification that uniquely identifies a communication I/F for connecting to the communication line and may also be an identification that uniquely identifies a network connected via a communication line (hereinafter, referred to as a permitted network). The identification is, for example, an IP address, a subnet mask, a network number, or the like. The pieces of permission information may be set by the administrator individually or may be set in accordance with a predetermined condition such as a default value.

The information management unit 101 also stores and manages a workflow acquired by the information acquisition unit 102 (described later) and usage information in association with each other, the usage information indicating the communication line or the like used in receiving the workflow. In other words, the information management unit 101 stores and manages workflow information regarding the acquired workflow and the usage information in association with each other, the usage information indicating the communication line or the like used in receiving the workflow information.

For the workflow information, an identification such as a workflow ID that uniquely identifies a workflow, a workflow name, process information regarding processes included in the workflow, and the like are cited. The process information includes a process-related instruction, detailed process setting information, and the like. For the usage information, identifications or the like that uniquely identifies a communication line, a communication I/F, and a network (hereinafter, referred to as a used network) used in receiving the workflow directed to the utilizer are cited.

The information management unit 101 also stores and manages an address book and history information regarding executed processes on a per communication line basis. In other words, the information management unit 101 stores and manages an address book and history information regarding executed processes for each communication I/F and for each network. For the address book, the IP address of an information apparatus allowed to exchange data therewith, an e-mail address representing an e-mail destination, and the like are cited. For the history information, the workflow information regarding a workflow executed in the image processing apparatus 10, a date and time when processes in the workflow are executed, and the like are cited.

The information acquisition unit 102 acquires various pieces of information. For example, the information acquisition unit 102 acquires input information regarding input received by the input unit 17 of the image processing apparatus 10 (see FIG. 2). In addition, for example, the information acquisition unit 102 acquires various pieces of information transmitted from the external information apparatuses such as the workflow systems 21 and 31. Examples of the information transmitted from the workflow systems 21 and 31 and included in the pieces of information acquired by the information acquisition unit 102 include workflow information regarding a workflow that is a workflow directed to the utilizer and that includes processes to be executed by the image processing apparatus 10.

The identification unit 103 identifies a user who operates the image processing apparatus 10 on the basis of the various pieces of information. For example, the identification unit 103 identifies a utilizer on the basis of information used for user authentication for using the image processing apparatus 10. The identification unit 103 also identifies permission information associated with the user information regarding the utilizer.

For example, the identification unit 103 also identifies the administrator on the basis of information used for the user authentication for managing the image processing apparatus 10 (hereinafter, referred to as management authentication).

In addition, for example, the identification unit 103 may identify the administrator on the basis of a right assigned to the utilizer identified in the user authentication for using the image processing apparatus 10. Specifically, if the utilizer is assigned a right to manage the image processing apparatus 10, the identification unit 103 may identify the utilizer as the administrator. If the utilizer is assigned a right to correct permission information, the identification unit 103 may identify the utilizer as being equivalent to the administrator.

The information analysis unit 104 analyzes various pieces of information. For example, the information analysis unit 104 analyzes the permission information identified by the identification unit 103. Specifically, the information analysis unit 104 analyzes the permission information associated with the user information regarding the utilizer. The information analysis unit 104 permits the utilizer to access the communication I/F connected to the communication line indicated by the permission information. In other words, the information analysis unit 104 decides, for the utilizer, a permitted network to be connected through the communication line indicated by the permission information.

The information analysis unit 104 also analyzes the workflow acquired by the information acquisition unit 102. Specifically, the information analysis unit 104 analyzes the usage information indicting the communication line or the like used in receiving the workflow on the basis of the permission information. The information analysis unit 104 permits the display 18 to display the content of an information-consistent workflow and causes a display 18 to report warning to the utilizer without permitting the displaying of the content of the information-inconsistent workflow. The information analysis unit 104 reports to the administrator that there is a workflow associated with usage information that does not match permission information.

The display controller 105 performs control to cause the display 18 to display various pieces of information. For example, the display controller 105 performs control to cause the display 18 to display the content of a workflow permitted to be displayed by the information analysis unit 104. The content of the workflow is process information regarding the workflow, a workflow name, or the like. The display controller 105 also performs control to cause the display 18 to display, for example, a warning image as information for warning the utilizer of a workflow not permitted to be displayed by the information analysis unit 104. The display controller 105 also performs control to cause the display 18 to display, as a report to the administrator, for example, the workflow name of a workflow not permitted to be displayed by the information analysis unit 104, a cause of the inconsistency between the permission information and the usage information, or the like.

The transmission controller 106 performs control to transmit various pieces of information. Specifically, the transmission controller 106 performs control to transmit various pieces of information to the workflow systems 21 and 31 and the external information apparatuses. Examples of information transmitted to the workflow systems 21 and 31 and included in the pieces of information transmitted under the control of the transmission controller 106 include information representing a request for a workflow directed to a utilizer. Examples of information transmitted to the external information apparatuses and included in the pieces of information transmitted under the control of the transmission controller 106 include information reported to the administrator such as the workflow name of a workflow not permitted to be displayed by the information analysis unit 104 and a cause of the inconsistency between the permission information and the usage information.

### Configuration of External Apparatuses Connected to Image Processing Apparatus 10

The workflow systems 21 and 31 according to this exemplary embodiment, the terminal apparatuses 22 and 32, and the document management servers 23 and 33 each have the same hardware configuration as the configuration of the image processing apparatus 10 illustrated in FIG. 2 except the image reading unit 14, the image forming unit 15, and the image processing unit 16. In other words, the workflow systems 21 and 31, the terminal apparatuses 22 and 32, and the document management servers 23 and 33 each have a controller, a secondary memory, a communication unit, an input unit, and a display that have the same functions as those of the controller 11, the secondary memory 12, the communication unit 13, the input unit 17, and the display 18 that are illustrated in FIG. 2, and thus illustration thereof is omitted. The workflow systems 21 and 31 and the document management servers 23 and 33 do not have to have the same configuration as those of the input unit 17 and the display 18.

The workflow systems 21 and 31 according to this exemplary embodiment, the terminal apparatuses 22 and 32, and the document management servers 23 and 33 also each have a function of managing various pieces of information, a function of acquiring various pieces of information, a function of analyzing various pieces of information, and a function of controlling transmission of various pieces of information. When having a display, the workflow systems 21 and 31, the terminal apparatuses 22 and 32, and the document management servers 23 and 33 have a function of controlling the displaying on the display.

### Processing Flow

### Flow of Process for Reporting Warning

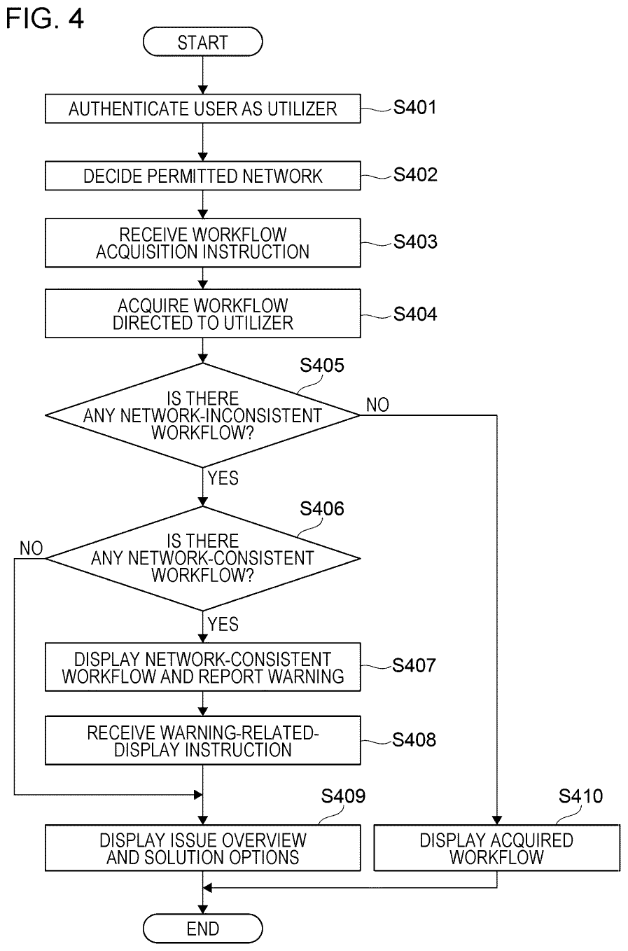

FIG. 4 is a flowchart indicating an example flow of a process for reporting warning to a utilizer. FIG. 4 illustrates an example of acquiring at least one workflow directed to a utilizer.

The image processing apparatus 10 authenticates a user as a utilizer (S401). The image processing apparatus 10 decides a permitted network permitted to be used by the utilizer (S402). Specifically, the image processing apparatus 10 identifies, as a utilizer, the user authenticated in the user authentication for using the image processing apparatus 10 and decides a permitted network on the basis of the permission information associated with the user information regarding the utilizer.

Subsequently, the image processing apparatus 10 receives an instruction to acquire a workflow, from the utilizer via the input unit 17 (see FIG. 2) (S403). The image processing apparatus 10 acquires a workflow directed to the utilizer on the basis of the workflow acquisition instruction from the utilizer (S404).

The image processing apparatus 10 then identifies whether there is any workflow with the used network that does not match the permitted network (also referred to as a network-inconsistent workflow) in the acquired workflow (S405). Specifically, the image processing apparatus 10 identifies whether there is any workflow associated with the usage information that does not match the permission information.

If there is a network-inconsistent workflow (YES in S405), the image processing apparatus 10 identifies whether the acquired workflow includes a workflow with the used network that matches the permitted network (also referred to as a network-consistent workflow) in (S406). Specifically, the image processing apparatus 10 identifies whether there is any workflow associated with the usage information that matches the permission information.

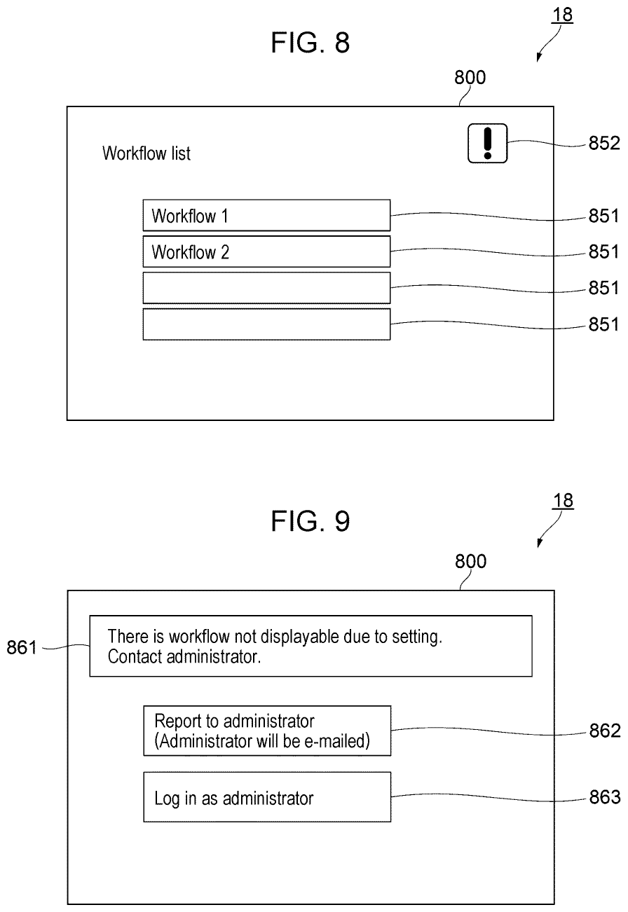

If there is a network-consistent workflow (YES in S406), the image processing apparatus 10 displays the network-consistent workflow and reports warning to the utilizer (S407). In other words, the image processing apparatus 10 does not display the network-inconsistent workflow and reports the warning to the utilizer. Examples of the utilizer warning report include a warning button 852 (described later) (see FIG. 8), sound, light, vibration, and e-mail.

The image processing apparatus 10 then receives a warning-display-related instruction from the utilizer via the input unit 17 (S408). The image processing apparatus 10 displays the overview of the issue for warning and solution options on the display 18 on the basis of the warning-display-related instruction by the utilizer (S409) and terminates the process. Specifically, in a state where the content of the network-inconsistent workflow is not displayed to the utilizer, the image processing apparatus 10 reports the issue overview and presents the solution options to achieve a solution to the issue. Examples of the solution options to achieve a solution to the issue include reporting the occurrence of an issue to the administrator and achieving the solution by the utilizer serving as the administrator.

If there is not any network-consistent workflow in step S406 (NO in S406), the image processing apparatus 10 displays the overview of the issue for warning and the solution options on the display 18 without reporting the warning to the utilizer (S409) and terminates the process. Specifically, even though the warning-display-related instruction by the utilizer is not received, the image processing apparatus 10 displays the overview of the issue for warning and the solution options on the display 18.

If there is not any network-inconsistent workflow in step S405 (NO in S405), the image processing apparatus 10 displays the acquired workflow on the display 18 (S410) and terminates the process. Specifically, the image processing apparatus 10 does not report the warning to the utilizer and displays the acquired workflow on the display 18.

If a workflow directed to the utilizer is not acquired in step S404, the warning to the utilizer is not reported, and any workflow is not displayed on the display 18.

### Flow of Process for Reporting to Administrator

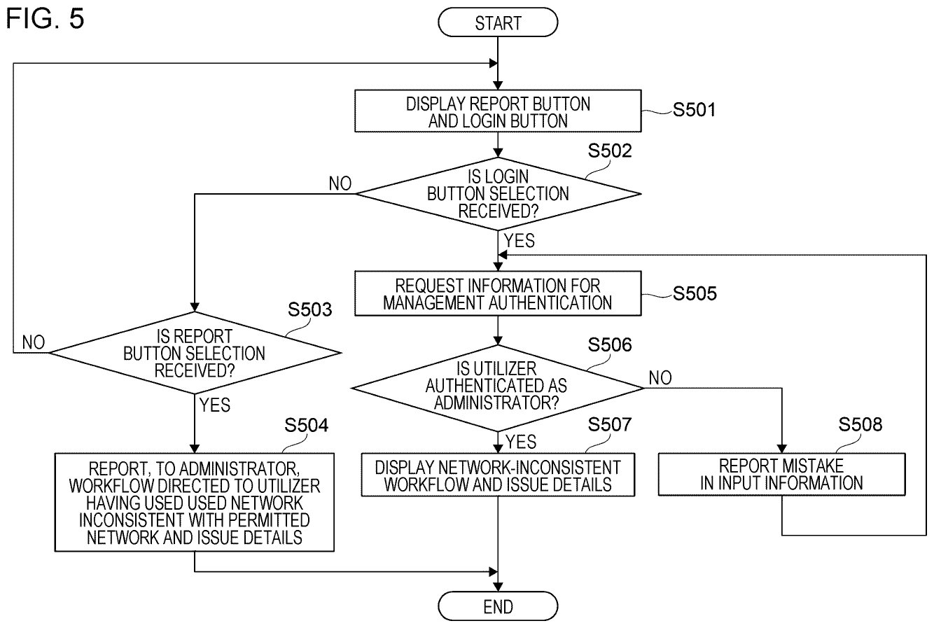

FIG. 5 is a flowchart indicating the flow of a process for reporting to the administrator. FIG. 5 illustrates an example where there is a network-inconsistent workflow and an issue occurrence report to the administrator and administrator login by the utilizer are presented as the solution options in step S409 in FIG. 4.

The image processing apparatus 10 displays, on the display 18 (see FIG. 2), a report button with which an instruction related to an issue occurrence report to the administrator is received and a login button with which an instruction related to the administrator login by the utilizer is received (S501).

The image processing apparatus 10 identifies whether the selection of the login button by the utilizer is received via the input unit 17 (see FIG. 2) (S502).

If the selection of the login button is not received (NO in S502), the image processing apparatus 10 identifies whether the selection of the report button by the utilizer is received via the input unit 17 (S503).

If the selection of the report button is not received (NO in S503), the image processing apparatus 10 repeats step S501 until the selection of the login button or the report button is received.

If the selection of the report button is received in step S503 (YES in S503), the image processing apparatus 10 reports, to the administrator, a workflow directed to the utilizer having used the used network inconsistent with the permitted network and the details of the issue (S504) and terminates the process.

If the selection of the login button is received in step S502 (YES in S502), the image processing apparatus 10 requests information for management authentication from the utilizer (S505). Specifically, the image processing apparatus 10 displays, on the display 18, an input field or the like for receiving the information for the management authentication.

The image processing apparatus 10 then identifies whether the utilizer is authenticated as the administrator (S506). Specifically, the image processing apparatus 10 verifies the information input by the utilizer and identifies whether the management authentication succeeds.

If the utilizer is authenticated as the administrator (YES in S506), the image processing apparatus 10 displays the network-inconsistent workflow and the details of the issue on the display 18 (S507) and terminates the process. Specifically, the image processing apparatus 10 presents, to the utilizer who is the administrator, information that identifies a workflow acquired but not displayed and information indicating that the workflow is not displayed because the used network and the permitted network do not match.

In contrast, if the utilizer is not authenticated as the administrator (NO in S506), the image processing apparatus 10 reports a mistake in the input information to the utilizer (S508) and repeats step S505 until correct information is input.

The reporting is not limited to the example described above. Regardless of whether the report button is selected, the image processing apparatus 10 may report, to the administrator, the workflow directed to the utilizer having used the used network inconsistent with the permitted network and the details of the issue. Specifically, if the image processing apparatus 10 identifies that the utilizer and the administrator are respective different users on the basis of the right assigned to the utilizer, the image processing apparatus 10 may report, to the administrator by using e-mail or the like, the workflow directed to the utilizer having used the used network inconsistent with the permitted network and the details of the issue.

If the utilizer does not input the information for the management authentication, the image processing apparatus 10 may display the network-inconsistent workflow and the details of the issue on the display 18. Specifically, if the right to manage the image processing apparatus 10 or the right to correct the permission information is assigned to the utilizer, the image processing apparatus 10 may display the network-inconsistent workflow and the details of the issue on the display 18 without requesting the management authentication information from the utilizer.

### Example Display on Display 18

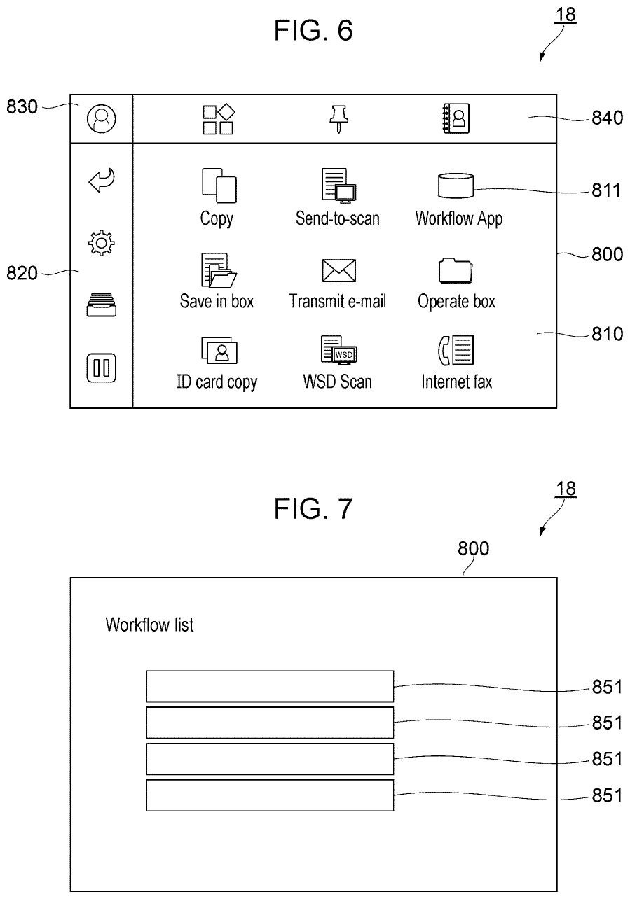

FIG. 6 is a view illustrating one of example displays on the display 18 to which this exemplary embodiment is applied.

In this exemplary embodiment, when the image processing apparatus 10 is started or to be used, an operation screen 800 for receiving an operation by a user is displayed on the display 18 (see FIG. 2). A pointer image that moves in accordance with the operation of the input unit 17 (see FIG. 2) by the user may be displayed on the operation screen 800.

In the example display illustrated in FIG. 6, the operation screen 800 has a selection area 810 where button images for receiving the selection of application software (hereinafter, referred to as an app) used in the image processing apparatus 10 are displayed. The operation screen 800 illustrated in FIG. 6 is a screen first displayed in using the various functions of the image processing apparatus 10, that is, what is called a home screen. The operation screen 800 may also have a control area 820, a control area 820, an authentication area 830, and a tab area 840. In the control area 820, instruction images for receiving the control of the image processing apparatus 10 itself are displayed. In the authentication area 830, an image related to the user authentication is displayed. In the tab area 840, tabs for receiving an instruction to change the indicators on the operation screen 800 are displayed.

In the selection area 810, information regarding an app selectable by an authenticated user is displayed. In the example illustrated in FIG. 6, the button images for respective apps that implement various functions are displayed in the selection area 810. The button images are used to receive an app access instruction from the user. In this exemplary embodiment, a selection button 811 associated with Workflow App that is an app for executing processes included in the workflow directed to a utilizer is displayed in the selection area 810.

The selection button 811 is a button image used to receive an instruction to access Workflow App from the user. If the user is authenticated as the utilizer, the selection button 811 receives an instruction to acquire a workflow directed to the utilizer. If the selection button 811 is selected by the utilizer, an access is made to associated Workflow App, and a list of workflows directed to the utilizer and information-consistent workflows is displayed on the operation screen 800. If the user is authenticated as the administrator, the selection button 811 may be used to receive an instruction related to the settings of associated Workflow App.

The multiple instruction images may be displayed in the control area 820 in accordance with the type of the control of the image processing apparatus 10 itself.

The authenticated user information regarding the user is displayed in the authentication area 830. The displayed user information may be displayed by using not only a picture or a symbol but also a photo of the user, a user name, an assigned right, or the like. If the authentication area 830 is selected by the user, an instruction to display an authentication screen for receiving information for the user authentication may be received.

Multiple tabs may be displayed in the tab area 840 in accordance with the content displayed in a switching manner. The content displayed in a switching manner is history information regarding processes as a target for the instruction given by the authenticated user, destination information for identifying a communication destination, or information regarding an app selectable by the authenticated user.

FIG. 7 is a view illustrating a different one of the example displays on the display 18 to which this exemplary embodiment is applied.

In this exemplary embodiment, if the utilizer selects the selection button 811 associated with Workflow App illustrated in FIG. 6, the operation screen 800 with Workflow App accessed is displayed on the display 18 (see FIG. 2) as illustrated in FIG. 7.

In the example display illustrated in FIG. 7, the operation screen 800 has workflow name fields 851 in which the workflow names of workflows presentable to a utilizer are displayed. The term “workflow presentable to a utilizer” denotes a workflow having the content thereof permitted to be displayed on the display 18. The operation screen 800 having the multiple workflow name fields 851 is a screen for displaying a list of the workflow names of workflows, that is, a so-called list screen.

Each workflow name field 851 is a display field where the workflow name of a workflow that is directed to the utilizer and is an information-consistent workflow is displayed. The workflow name field 851 does not display the workflow name of an information-inconsistent workflow even though the workflow is directed to the utilizer. In other words, the workflow name field 851 does not display the workflow name of a workflow having the content thereof not permitted to be displayed on the display 18.

The operation screen 800 illustrated in FIG. 7 is a screen for a case where there is neither workflow presentable to the utilizer nor a workflow not presentable due to inconsistency between the usage information and the permission information and thus is a list screen where the workflow name fields 851 are blank. Specifically, if the image processing apparatus 10 does not acquire any workflow directed to the utilizer, the blank list screen is displayed.

FIG. 8 is a view illustrating a different one of the example displays on the display 18 to which this exemplary embodiment is applied.

Unlike the example illustrated in FIG. 7, FIG. 8 illustrates an example where the image processing apparatus 10 acquires workflows directed to the utilizer. Specifically, FIG. 8 illustrates the example where the image processing apparatus 10 acquires workflows presentable to the utilizer and at least one workflow not presentable.

In this exemplary embodiment, if the utilizer selects the selection button 811 illustrated in FIG. 6, warning to the user is reported, and the screen having a list of the presentable workflows is displayed on the display 18 (see FIG. 2), as illustrated in FIG. 8. In other words, in this exemplary embodiment, if the utilizer selects the selection button 811 illustrated in FIG. 6, and if the multiple workflows directed to the utilizer are received, each workflow with its associated usage information that matches the permission information is displayed on the display 18 having the warning image displayed thereon, as illustrated in FIG. 8.

In the example display illustrated in FIG. 8, the warning button 852 is displayed on the operation screen 800 having the workflow name fields 851, the warning button 852 being an image for warning the utilizer of the workflow not permitted to be displayed. In the example illustrated in FIG. 8, the image processing apparatus 10 acquires two workflows presentable to the utilizer, and the workflow name “Workflow 1” and “Workflow 2” are displayed in the respective workflow name fields 851. In addition, two of the four workflow name fields 851 are blank. The number of workflow name fields 851 may be changed on the basis of the number of workflows presentable to the utilizer.

If the utilizer selects one of the displayed workflow names, the workflow name field 851 may receive an instruction related to the execution of the processes included in the workflow having the workflow name displayed in the display field. The workflow name fields 851 are not limited to the display fields having the respective workflow names displayed on a per-workflow basis, and the multiple workflow names may be displayed in one display field. If the utilizer selects one of the displayed workflow names, the workflow name field 851 may receive an instruction related to the execution of the processes included in the workflow the workflow name of which is selected.

The warning button 852 serving as an example of the warning image is an image used to warn the utilizer if there is a workflow not displayable on the display 18 due to the inconsistency between the associated the usage information and the permission information. In other words, the warning button 852 is an image representing that there is a workflow not displayable on the display 18 due to the inconsistency between the associated the usage information and the permission information. Specifically, the warning button 852 is an image displayed on the list screen if a workflow is acquired through a communication line not permitted to be used by the utilizer. The warning button 852 is an image for causing the utilizer to notice the occurrence of an issue and is a picture, a symbol, a message, or combination of these. The warning button 852 does not report up to the content, such as the workflow name, of the workflow not displayable on the display 18 due to the inconsistency between the associated the usage information and the permission information.

The warning button 852 is also a button image used to receive an instruction to display the issue overview and the solution options from the utilizer. If the utilizer selects the warning button 852, the issue overview required to be reported to the administrator is presented to the utilizer, and options that prompt the utilizer to address the issue are presented on the operation screen 800.

The warning button 852 is not limited to the example described above and may be displayed on the operation screen 800 on which all of the workflow name fields 851 are blank. Specifically, if there is not any workflow presentable to the utilizer, but if there is at least one workflow not presentable due to the inconsistency between the usage information and the permission information, the warning button 852 may be displayed on the blank list screen as illustrated in FIG. 7.

FIG. 9 is a view illustrating a different one of the example displays on the display 18 to which this exemplary embodiment is applied.

In this exemplary embodiment, if the utilizer selects the warning button 852 illustrated in FIG. 8, the operation screen 800 having the overview of the issue for warning and the solution options presented thereon is displayed on the display 18 (see FIG. 2), as illustrated in FIG. 9.

The operation screen 800 illustrated in FIG. 9 is a screen for presenting, to the utilizer, the overview of the issue with the image processing apparatus 10 and solution options for the issue. In the example display illustrated in FIG. 9, the operation screen 800 has an overview field 861, a report button 862, and a login button 863. The overview field 861 represents the overview of the issue warning by using the warning button 852. The report button 862 is used to receive an instruction to report the issue occurrence to the administrator. The login button 863 is used to receive an instruction related to the administrator login by the utilizer.

The overview field 861 is a display field in which the presence of a workflow not displayable on the display 18 due to the inconsistency between the associated the usage information and the permission information is displayed more specifically than with the warning button 852. The overview field 861 does not display up to the content, such as the workflow name, of the workflow. In the example illustrated in FIG. 9, a message is displayed in the overview field 861, but it suffices that the presence of a workflow not displayable due to a setting by the administrator is represented. The overview field 861 may represent an error code, a picture, a symbol, or combination thereof.

The report button 862 is an image for receiving, from the utilizer, an instruction to report to the administrator that there is a workflow associated with the usage information that does not match the permission information. In the example illustrated in FIG. 9, if the utilizer selects the report button 862, e-mail reporting that there is a workflow not displayable due to a setting by the administrator is transmitted to the administrator. Examples of the information reported to the administrator include information indicating the cause of the inconsistency between the permission information and the usage information and workflow information regarding the workflow not displayable due to a setting by the administrator. The information indicating the cause of the inconsistency between the permission information and the usage information includes information indicating that the permitted network set by the administrator does not match the used network, information regarding the details of the target permission information and the usage information, and the like.

The login button 863 is an image for receiving, from the utilizer, an intention to perform a login operation as the administrator of the image processing apparatus 10. For example, if the utilizer selects the login button 863, information required for the management authentication for managing the image processing apparatus 10 is required to be input.

The operation screen 800 illustrated in FIG. 9 is not limited to the example described above and may be displayed if the utilizer does not select the warning button 852 illustrated in FIG. 8. Specifically, the operation screen 800 illustrated in FIG. 9 may be displayed on the display 18 if the utilizer selects the selection button 811 in FIG. 6, if there is no workflow presentable to the utilizer, and if there is a workflow not presentable due to the inconsistency between the usage information and the permission information.

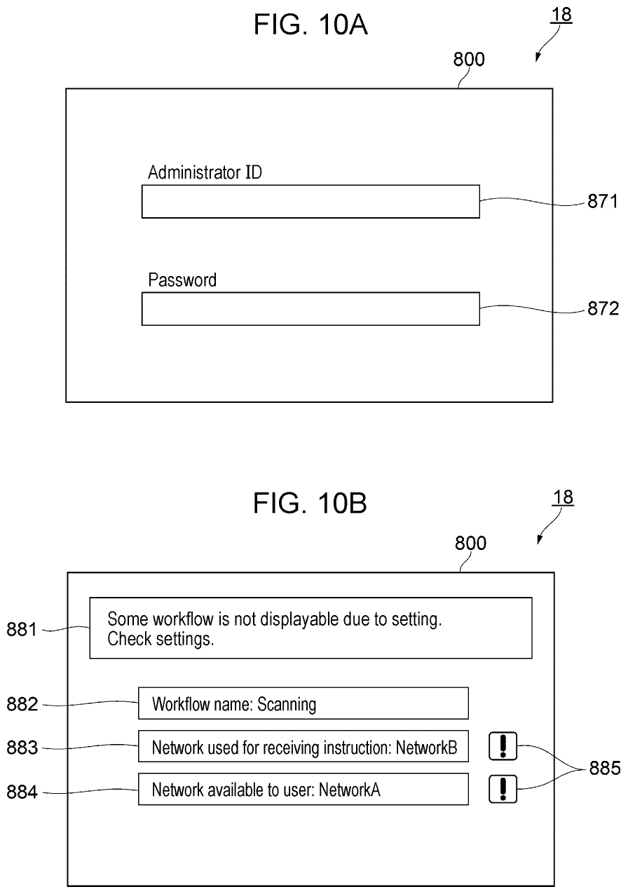

FIGS. 10A and 10B are each a view illustrating a different one of the example displays on the display 18 to which this exemplary embodiment is applied. FIG. 10A illustrates the operation screen 800 for receiving administrator login, and FIG. 10B illustrates the operation screen 800 displaying the report to the administrator.

In this exemplary embodiment, if the utilizer selects the login button 863 illustrated in FIG. 9, the operation screen 800 for receiving the administrator login is displayed on the display 18 (see FIG. 2), as illustrated in FIG. 10A.

The operation screen 800 illustrated in FIG. 10A is a screen having an input field for receiving the input of information for the management authentication, that is, what is called an authentication screen, the input being performed by the utilizer with the input unit 17 (see FIG. 2). In the example display illustrated in FIG. 10A, the operation screen 800 has an administrator ID input field 871 for receiving the input of an administrator ID that is a user ID that uniquely identifies the administrator and a password input field 872 for receiving the input of a password associated with the administrator ID.

If the utilizer is authenticated as the administrator on the basis of the administrator ID and the password that are input from the operation screen 800 illustrated in FIG. 10A, the operation screen 800 having the report to the administrator displayed thereon is displayed on the display 18, as illustrated in FIG. 10B. In other words, if the management authentication succeeds, the operation screen 800 transitions to the screen illustrated in FIG. 10B from the screen illustrated in FIG. 10A.

The operation screen 800 illustrated in FIG. 10B is a screen for reporting, to the administrator, the details of the content of the warning using the warning button 852 (see FIG. 8), that is, what is called a report screen. Examples of the details of the content of the warning using the warning button 852 include information indicating the cause of the inconsistency between the permission information and the usage information and workflow information regarding the workflow not displayable due to a setting by the administrator.

In the example display illustrated in FIG. 10B, the operation screen 800 has an explanation field 881 that explains the warned issue and an undisplayed workflow name field 882 that displays the workflow name of a workflow the workflow name of which is not displayed in the workflow name field 851. The operation screen 800 also has a usage information field 883 in which the usage information is displayed and a permission information field 884 in which the permission information is displayed. In addition, emphasis images 885 that emphasize the cause of the issue may be displayed on the operation screen 800.

The explanation field 881 is an explanation field for explaining, to the administrator, the presence of a workflow not displayable due to a setting by the administrator and the necessity for checking the settings. In the example illustrated in FIG. 10B, a message is displayed in the explanation field 881, but an error code, a picture, a symbol, or combination thereof may be displayed.

The undisplayed workflow name field 882 is a display field in which a workflow name is displayed as the workflow information regarding the workflow not displayable due to a setting by the administrator. In the example illustrated in FIG. 10B, Workflow name and Scanning are displayed in the undisplayed workflow name field 882, Workflow name indicating an item to be displayed, Scanning serving as the name of the workflow not displayable due to a setting by the administrator.

The usage information field 883 is a display field in which information indicating a difference in the target usage information from the permission information regarding the utilizer is displayed. The permission information field 884 is a display field in which information indicating a difference in the target permission information from the usage information associated with a workflow not displayable due to a setting by the administrator is displayed. In other words, the usage information field 883 and the permission information field 884 are each a display fields in which an item having an information difference between the target usage information and the permission information is displayed.

In the example illustrated in FIG. 10B, in the usage information field 883, “Network used for receiving instruction” indicating an item to be displayed and “NetworkB” serving as the network name of the used network used in receiving the workflow directed to the utilizer are displayed. In the permission information field 884, “Network available to user” indicating an item to be displayed and “NetworkA” serving as the network name of the permitted network permitted to be used if the user is a utilizer are displayed. The items displayed in the usage information field 883 and the permission information field 884 are not limited to the network name and are only required to be an item that identifies a communication line, a communication I/F, or a network.

Each emphasis image 885 is an image for causing the administrator to verify the cause of the issue and is thus an image that emphasizes information inconsistency between the target usage information and the permission information. In the example illustrated in FIG. 10B, the emphasis images 885 is displayed on the right side of a corresponding one of the usage information field 883 and the permission information field 884.

The form of displaying the emphasis image 885 is not limited to the example illustrated in FIG. 10B. Specifically, it suffices that the emphasis image 885 is displayed at a position associated with a corresponding one of the usage information field 883 and the permission information field 884. The emphasis image 885 may be located on the left side, the lower side, or the upper side of a corresponding one of the usage information field 883 and the permission information field 884 or may be located at a position overlapping with a corresponding one of the usage information field 883 and the permission information field 884. In addition, the emphasis image 885 is only required to be an image for emphasis and may be an arrow image pointing at a corresponding one of the usage information field 883 and the permission information field 884, a frame image surrounding a corresponding one of the usage information field 883 and the permission information field 884, a message image associated with a corresponding one of the usage information field 883 and the permission information field 884, or another image. The emphasis image 885 may be displayed in association with a corresponding one of the usage information field 883 and the permission information field 884 but may be associated with one of the usage information field 883 and the permission information field 884.

The operation screen 800 illustrated in FIG. 10B is not limited to the example described above and may be displayed without transitioning from the authentication screen as illustrated in FIG. 10A. Specifically, if the utilizer selects the login button 863 illustrated in FIG. 9, and if the utilizer is assigned the right to manage the image processing apparatus 10 or the right to correct the permission information, the cause of the inconsistency between the permission information and the usage information may be displayed on the display 18 without requesting the information for the management authentication from the utilizer, as illustrated in FIG. 10B.

### Modifications

(1) The exemplary embodiment of the present disclosure has heretofore been described. However, the technical scope of the disclosure is not limited to the scope of the exemplary embodiment. From the description of the scope of claims, it is apparent that the technical scope of the disclosure includes various modifications and improvements made to the exemplary embodiment.

(2) If the user who uses the information processing apparatus is assigned the right to correct the permission information, a correction button may be displayed on the display having the cause of the inconsistency between the permission information and the usage information displayed thereon, the correction button being an image for receiving, from the user, an instruction to correct the permission information. The correction button is displayed on the screen for reporting, to the user, the details of the content warned by using the warning image. The correction button may be, for example, the display field displaying the usage information or an image associated with the display field on the operation screen as illustrated in FIG. 10B or may be displayed separately. The correction button may also be configured not to be displayed if the permission information is corrected to match the usage information.

(3) If the usage information does not match the permission information set by the user who uses the information processing apparatus, the warning image may be displayed on the display of the terminal apparatus held by the user, without displaying the workflow associated with the usage information. Specifically, the warning image may be displayed on the portable display for the utilizer that is separate from the information processing apparatus, that is, what is called a remote user interface, without displaying the workflow associated with the usage information.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system includes one or more processors configured to:
acquire a workflow directed to a user who uses an information processing apparatus and usage information in association with each other, the usage information indicating a communication line used in receiving the workflow by the information processing apparatus receiving workflows by using multiple independent communication lines including the communication line; and
in response to inconsistency between the usage information and permission information indicating a communication line of the communication lines that is permitted to be used by the user, report warning to the user without displaying, on a display, the workflow associated with the usage information.
   (((2)))

In the information processing system according to (((1))), the one or more processor are configured to:
display a warning image as the warning to the user on the display
   (((3)))

In the information processing system according to (((2))), the warning image is an image indicating that there is a workflow not displayable on the display due to the inconsistency between the associated usage information and the permission information.

(((4)))

In the information processing system according to (((2))) or (((3))),
the one or more processor are configured to:
   in response to the multiple workflows being received, display a workflow of the multiple workflows that is associated with the usage information that matches the permission information, the workflow being displayed on the display on which the warning image is displayed.
      (((5)))

In the information processing system according to any one of (((1))) to (((4))),
the one or more processor are configured to:
   in response to the inconsistency between the usage information and the permission information, report to an administrator that there is the workflow associated with the usage information.
      (((6)))

In the information processing system according to (((5))),
the one or more processor are configured to:
   report a cause of the inconsistency between the permission information and the usage information, as a report to the administrator.
      (((7)))

In the information processing system according to any one of (((1))) to (((4))),
the one or more processor are configured to:
   in response to the user being assigned a right to correct the permission information, display a cause of the inconsistency between the permission information and the usage information on the display.
      (((8)))

A program causes one or more computers to execute a process including:
acquiring a workflow directed to a user who uses an information processing apparatus and usage information in association with each other, the usage information indicating a communication line used in receiving the workflow by the information processing apparatus receiving workflows by using multiple independent communication lines including the communication line; and
in response to inconsistency between the usage information and permission information indicating a communication line of the communication lines that is permitted to be used by the user, reporting warning to the user without displaying, on a display, the workflow associated with the usage information.

What is claimed is:

1. An information processing system comprising:
one or more processors configured to:
acquire a workflow directed to a user who uses an information processing apparatus and usage information in association with each other, the usage information indicating a communication line used in receiving the workflow by the information processing apparatus receiving workflows by using a plurality of independent communication lines including the communication line; and
in response to inconsistency between the usage information and permission information indicating a communication line of the communication lines that is permitted to be used by the user, report warning to the user without displaying, on a display, the workflow associated with the usage information.

2. The information processing system according to claim 1,
wherein the one or more processor are configured to:
display a warning image as the warning to the user on the display.

3. The information processing system according to claim 2,
wherein the warning image is an image indicating that there is a workflow not displayable on the display due to the inconsistency between the associated usage information and the permission information.

4. The information processing system according to claim 2,
wherein the one or more processor are configured to:
in response to the plurality of workflows being received, display a workflow of the plurality of workflows that is associated with the usage information that matches the permission information, the workflow being displayed on the display on which the warning image is displayed.

5. The information processing system according to claim 3,
wherein the one or more processor are configured to:
in response to the plurality of workflows being received, display a workflow of the plurality of workflows that is associated with the usage information that matches the permission information, the workflow being displayed on the display on which the warning image is displayed.

6. The information processing system according to claim 1,
wherein the one or more processor are configured to:
in response to the inconsistency between the usage information and the permission information, report to an administrator that there is the workflow associated with the usage information.

7. The information processing system according to claim 6,
wherein the one or more processor are configured to:
report a cause of the inconsistency between the permission information and the usage information, as a report to the administrator.

8. The information processing system according to claim 1,
wherein the one or more processor are configured to:
in response to the user being assigned a right to correct the permission information, display a cause of the inconsistency between the permission information and the usage information on the display.

9. A non-transitory computer readable medium storing a program causing one or more computers to execute a process comprising:
acquiring a workflow directed to a user who uses an information processing apparatus and usage information in association with each other, the usage information indicating a communication line used in receiving the workflow by the information processing apparatus receiving workflows by using a plurality of independent communication lines including the communication line; and
in response to inconsistency between the usage information and permission information indicating a communication line of the communication lines that is permitted to be used by the user, reporting warning to the user without displaying, on a display, the workflow associated with the usage information.

10. An information processing method comprising:
acquiring a workflow directed to a user who uses an information processing apparatus and usage information in association with each other, the usage information indicating a communication line used in receiving the workflow by the information processing apparatus receiving workflows by using a plurality of independent communication lines including the communication line; and
in response to inconsistency between the usage information and permission information indicating a communication line of the communication lines that is permitted to be used by the user, reporting warning to the user without displaying, on a display, the workflow associated with the usage information.
